(19) United States
(12) Patent Application Publication
(10) Pub. No.: US 2015/0168783 A1
(43) Pub. Date: Jun. 18, 2015

(54) DIRECT TYPE BACKLIGHT MODULE

(71) Applicant: Hon Hai Precision Industry Co., Ltd., New Taipei (TW)

(72) Inventor: SHAO-HAN CHANG, New Taipei (TW)

(21) Appl. No.: 14/509,537

(22) Filed: Oct. 8, 2014

(30) Foreign Application Priority Data
Dec. 16, 2013 (CN) 201310684813.2

(51) Int. Cl. G02F 1/1335; F21K 99/00

(52) U.S. Cl. CPC G02F 1/133605; G02F 1/133603; F21K 9/50

(57) ABSTRACT

The present disclosure provides a direct type backlight module. The direct type backlight module includes a housing, a plurality of LED light sources, and a reflective sheet. The housing includes a bottom plate and a plurality of sidewalls. The LED light sources with a plurality of LEDs are positioned on an inner surface in an array. The reflective sheet is positioned on the inner surface. The direct type backlight module also includes a reflective plate. The reflective plate includes a plurality of reflective plate units arranged in an array. Each of the reflective plate units includes a plane portion and a protrusion portion circled by the plane portion. The protrusion portion faces one of the LEDs. The plane portion and the protrusion portion have a plurality of light transmitting holes.

### FIELD

The subject matter herein generally relates to backlight modules, and particularly, to a direct type backlight module.

### BACKGROUND

A liquid crystal display (LCD) has been applied in cell phones, laptops, personal computers (PC), personal digital assistants (PDA) and other consumer electronic products. Since the LCD panel of an LCD apparatus itself does not have the function of emitting light, a backlight module is needed to be positioned under the LCD panel to provide the LCD panel with a required light source so as to make the LCD panel display.

The typical backlight module can be divided into a direct-light type and an edge-light type according to the location of the light source. A conventional direct type backlight module includes a bezel, a frame, a light source, a light guide plate, a diffusion plate, and a number of optical films. The optical films are positioned above the diffusion plate. The diffusion plate is positioned above the light source and is located at a light mixing distance from the light source.

### BRIEF DESCRIPTION OF THE DRAWINGS

Implementations of the present technology will now be described, by way of example only, with reference to the attached figures.

FIG. 1 is a cross-sectional view of a direct type backlight module, in accordance with a first embodiment of this disclosure.

FIG. 2 is an enlarged view of circled portion II of the direct type backlight module as shown in FIG. 1.

FIG. 3 is an isometric view of a reflective plate of the direct type backlight module as shown in FIG. 1.

FIG. 4 is an exploded-isometric view of the direct type backlight module as shown in FIG. 1.

FIG. 5 is a diagrammatic view of the light path of the direct type backlight module as shown in FIG. 1.

FIG. 6 is a cross-sectional view of a direct type backlight module, in accordance with a second embodiment of this disclosure.

FIG. 7 is an isometric view of a reflective plate of the direct type backlight module as shown in FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to a direct type backlight module.

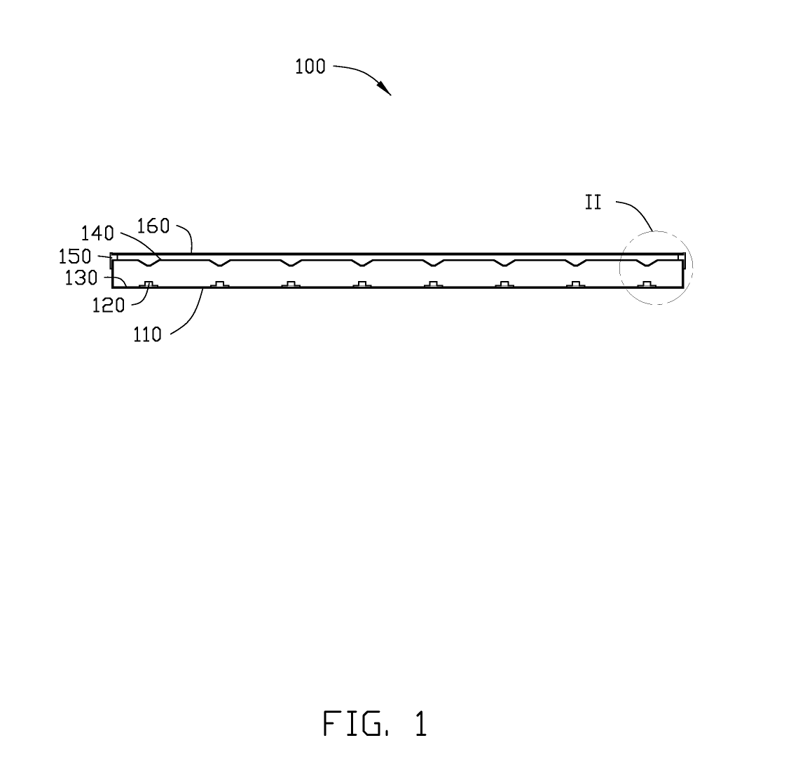

FIG. 1 illustrates a first embodiment of a direct type backlight module 100 of the disclosure. The direct type backlight module 100 can include a housing 110, a plurality of light-emitting-diode (LED) light sources 120, a reflective sheet 130, a reflective plate 140 mounted upon the housing 110, a plastic frame 150 positioned on and located at the periphery of the reflective plate 140, and an optical film 160 placed on the plastic frame 150. That is, the plastic frame 150 is sandwiched between the reflective plate 140 and the optical film 160.

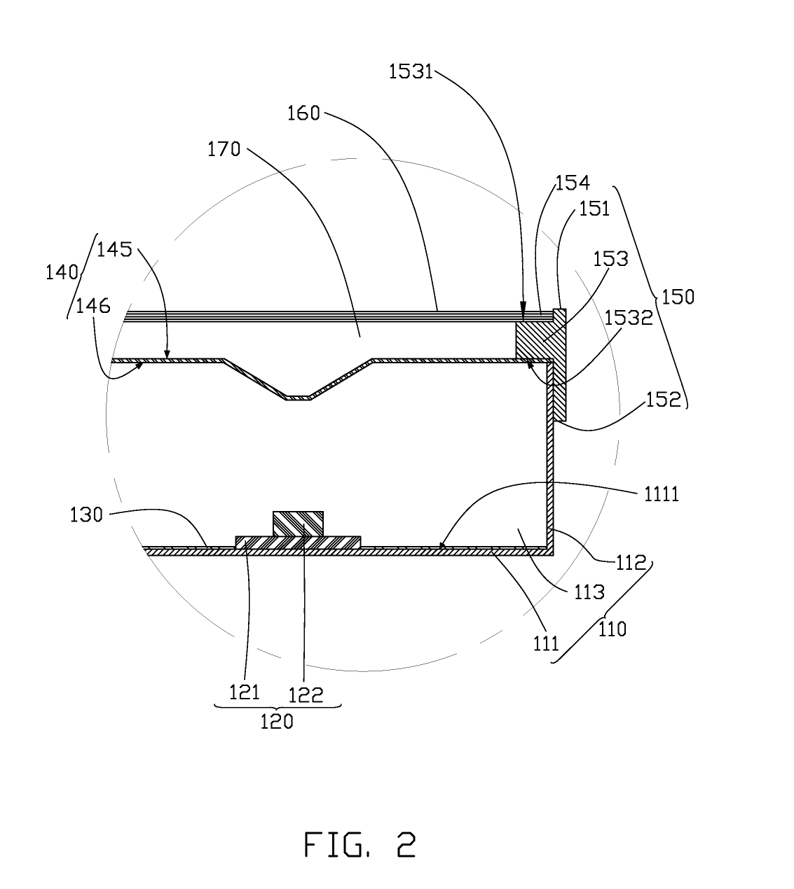

FIG. 2 illustrates that the housing 110 can include a bottom plate 111 and a plurality of sidewalls 112 vertically extending from sides of the bottom plate 111. The bottom plate 111 and the plurality of sidewalls 112 can cooperatively define a containing cavity 113, configured for receiving the plurality of LED light sources 120. The bottom plate 111 can include an inner surface 1111.

The shape of light sources 120 can be substantially bar, and the light sources 120 can include a striped substrate 121 and a plurality of LEDs 122 arranged upon the substrate 121. Each of the plurality of LEDs 122 can be direct type LED. The plurality of LED light sources 120 can be positioned upon the inner surface 1111 of the bottom plate 111 in an array. The plurality of stripped reflective sheets 130 can be positioned upon the inner surface 1111 of the bottom plate 111 and can be respectively positioned between two neighboring LED light sources 120, configured for reflecting the light from the plurality of LEDs 122 to the reflective plate 140.

The reflective plate 140 can include a light-emitting surface 145 and a light-entering surface 146 opposite to the light-emitting surface 145. The reflective plate 140 can be mounted upon the housing 110 and cover the containing cavity 113.

The plastic frame 150 can be substantially rectangular and include an upper frame 151, a lower frame 152, and a protrusion 153 located between the upper frame 151 and the lower frame 152. The protrusion 153 can include an upper surface 1531 and a lower surface 1532 opposite to the upper surface 1531. The upper frame 151 and the protrusion 153 can cooperatively define a receiving portion 154 for receiving the optical film 160. The lower frame 152 can be mounted upon the housing 110 and can be resisted with the sidewalls 112, the lower surface 1532 of the protrusion 153 can be resisted with the periphery of the light-emitting surface 145. The reflective plate 140 and the optical film 160 can cooperatively define a mixing light distance 170, the mixing light distance 170 can be equal to, or larger than, 0.2 millimeter (mm).

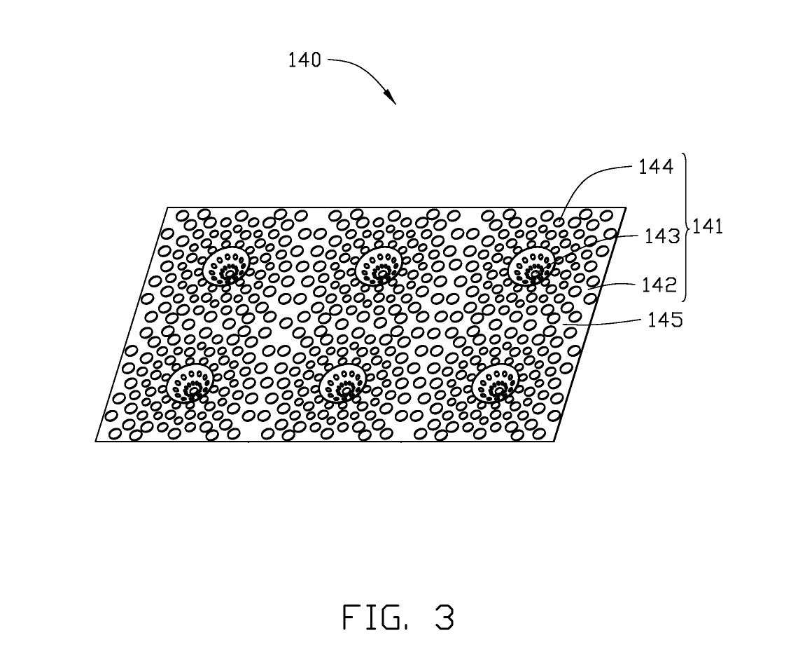

FIG. 3 illustrates that the reflective plate 140 can further include a plurality of reflective plate units 141 arranged in an array. Each of the reflective plate units 141 can include a plane portion 142 and a protrusion portion 143 circled by the plane portion 142. The protrusion portion 143 of each of the reflective plate units 141 can face one of the plurality of LEDs 122 (as shown in FIG. 2). The plane portion 142 and the protrusion portion 143 have a plurality of light transmitting holes 144. The protrusion portion 143 can be positioned on the center of each of the reflective plate units 141, and can be configured for reflecting the positive emergent light of the plurality of LEDs 122 (as shown in FIG. 2).

The shape of the light transmitting holes 144 can be circular or ellipsoidal. The transmitting holes 144 positioned on the protrusion portion 143 can be arranged in an array. The other transmitting holes 144 can be radially arranged on the plane portion 142. The aperture ratio per unit area of the transmitting holes 144 can increase as the distance to the corresponding one of the plurality of LEDs 122 (as shown in FIG. 2) increases. The number of the transmitting holes 144 per unit area can increase as the distance to the corresponding one of the plurality of LEDs 122 (as shown in FIG. 2) increases. Thereby the light from transmitting holes 144 can be uniformly distributed on the light-emitting surface 145.

The reflective plate 140 can be integrally formed from metal plate or plastic material with high reflectivity. The reflectivity of the metal plate and plastic material is above 0.8.

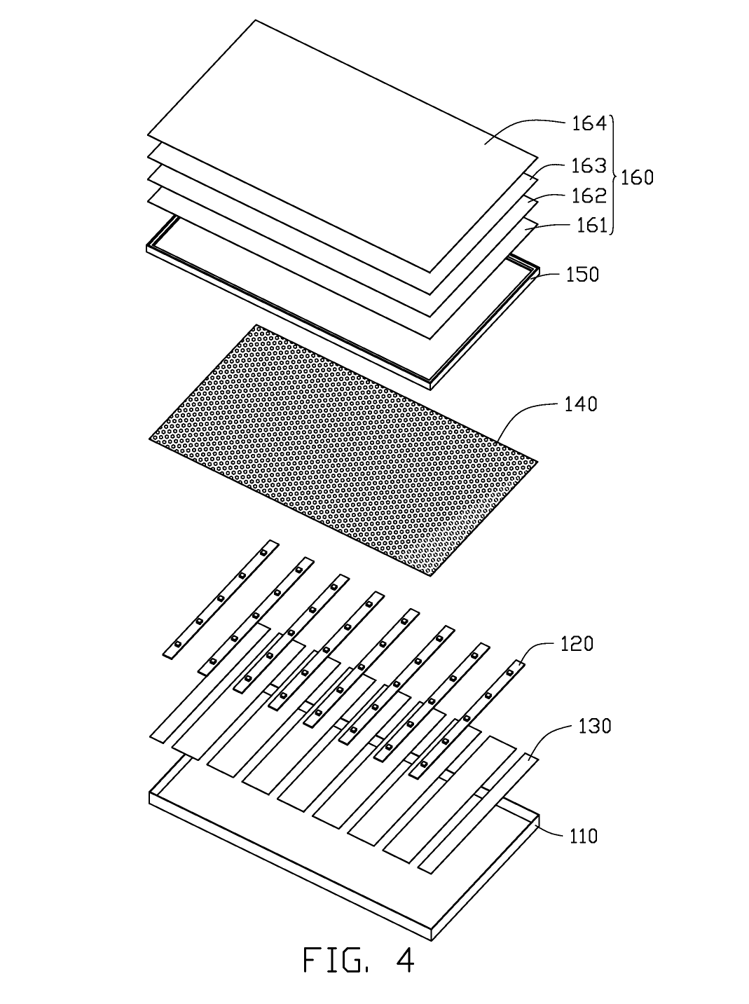

FIG. 4 illustrates that the optical film 160 can include a number of complementary optical elements. In the illustrated embodiment, the optical film 160 can include a first diffusion film 161, a first prism lens 162, a second prism lens 163, and a second diffusion film 164 stacked together in order. The optical film 160 can be received in the receiving portion 154, the first diffusion film 161 can be resisted with the upper surface 1531 of the protrusion 153 (see in FIG. 2).

In assembly, the plurality of the LED light sources 120 can be spaced with each other on the inner surface 1111 of the bottom plate 111, the reflective sheet 130 can be positioned on the part of the inner surface 1111 located between two LED light sources 120. Then the reflective plate 140 can be mounted upon the sidewalls 112 of the housing 110 and opposite to the containing cavity 113. The protrusion portion 143 of each of the reflective plate units 141 can correspond to each of the LEDs 122. After that the plastic frame 150 can be mounted upon the housing 110, and the lower frame 152 can be resisted with the sidewalls 112. At last, the optical film 160 can be received in the receiving portion 154.

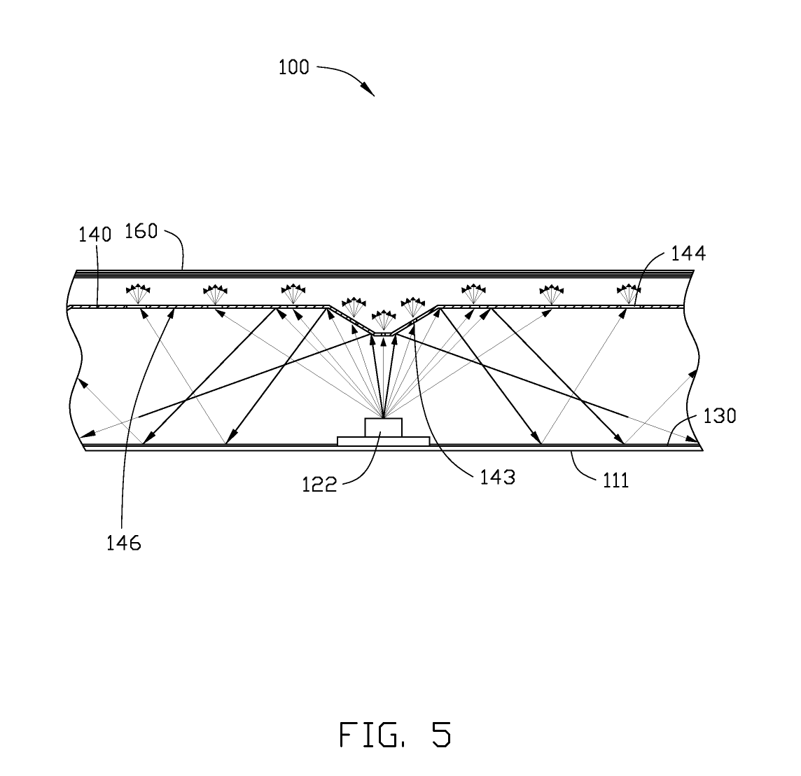

FIG. 5 shows a diagrammatic view of the light path of the direct type backlight module 100. In use, a part of the positive emergent light of the plurality of LEDs 122 can be emitted through the transmitting holes 144 of the protrusion portion 143. The protrusion portion 143 can reflect most of the positive emergent light of the plurality of LEDs 122. The reflected light can be emitted through the transmitting holes 144 around the protrusion portion 143, or reflected by the light-entering surface 146 of the reflective plate 140. A part of lateral emergent light of the plurality of LEDs 122 can be emitted through the transmitting holes 144 around the protrusion portion 143, and the other part of lateral emergent light of the plurality of LEDs 122 can be reflected by the light-entering surface 146 of the reflective plate 140. The reflected positive emergent light and lateral emergent light of the plurality of LEDs 122 can be repeatedly reflected between the reflective plate 140 and the reflective sheet 130 and emitted through the transmitting holes 144, thereby uniformly mixing the emitted light from the plurality of LEDs 122. Thus, the luminance uniformity of the direct type backlight module 100 can be improved.

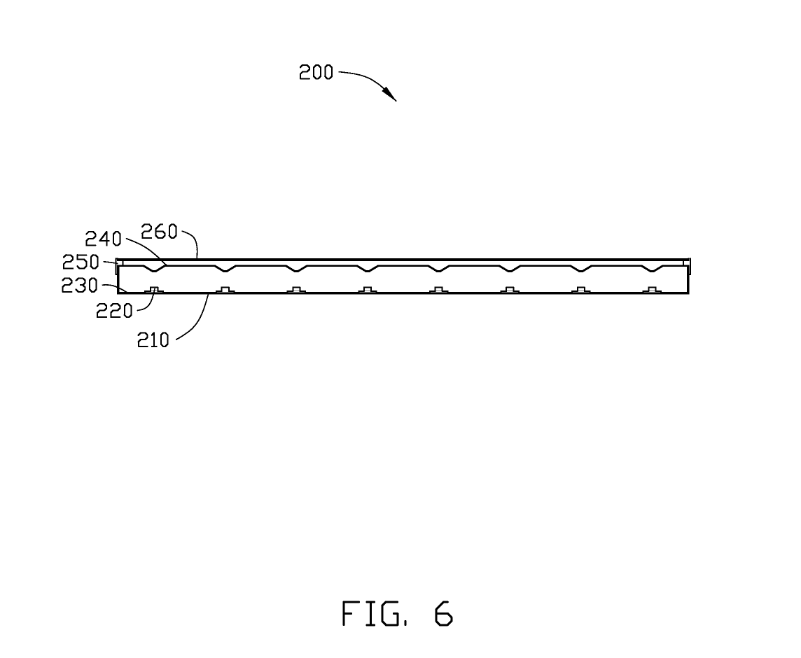

FIG. 6 illustrates a direct type backlight module 200 in a second embodiment of this disclosure. The backlight module 200 can include a housing 210, a plurality of LED light sources 220, a reflective sheet 230, a reflective plate 240 mounted upon the housing 210, a plastic frame 250 positioned on and located at the periphery of the reflective plate 240 and an optical film 260 placed on the plastic frame 250. The direct type backlight module 200 is the same as the first embodiment, except for the reflective plate 240.

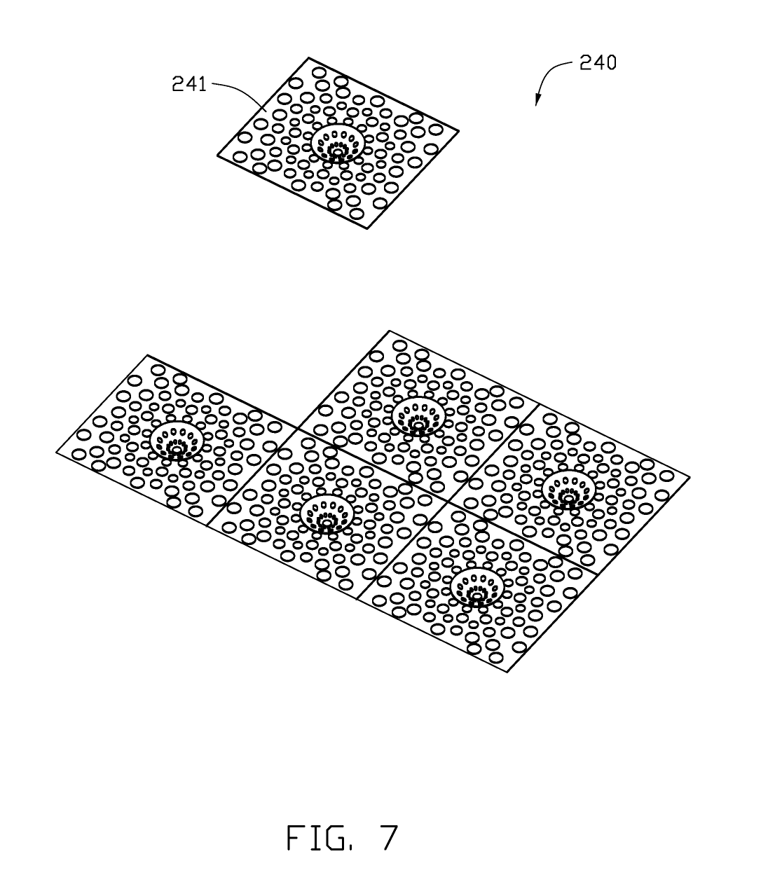

FIG. 7 illustrates the reflective plate 240 can be spliced together by a plurality of reflective plate units 241. Each of the plurality of reflective plate units 241 can be made of metal or plastic sheet with high reflectivity, and the reflectivity can be 0.8 or more. Each of the plurality of reflective plate units 241 can be rectangular.

As described above, the transmitting holes 144 and the protrusion portion 143 corresponding to each of the plurality of LEDs 122 can be positioned on the reflective plate 140. The protrusion portion 143 can reflect most of the positive emergent light of the LEDs 122, and the reflected positive emergent light can be repeatedly reflected by the reflective plate 140 and the reflective sheet 130 and uniformly mixed with the lateral emergent light of the plurality of LEDs 122. Therefore, the luminance uniformity and light utilization of direct type backlight module 100, 200 can improve. The present disclosure can realize both the high brightness and thin design of frame of edge-type backlight module 100, 200.

The embodiments shown and described above are only examples. Many details are often found in the art such as the other features of a direct type backlight module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A direct type backlight module comprising:
a housing including a bottom plate and a plurality of sidewalls vertically extending from sides of the bottom plate, the bottom plate and plurality of sidewalls connected with each other to cooperatively define a containing cavity;
a plurality of LED light sources positioned on an inner surface of the bottom plate in an array, wherein the LED light sources comprise a plurality of LEDs; and
a reflective sheet positioned on the inner surface of the bottom plate for reflecting the light of LEDs;
wherein a reflective plate includes a plurality of reflective plate units arranged in an array;
each of reflective plate units including a plane portion and a protrusion portion circled by the plane portion, the protrusion portion of each of reflective plate units faces one of the plurality of LEDs, and the plane portion and the protrusion portion have a plurality of light transmitting holes.

2. The direct type backlight module as claimed in claim 1, wherein the protrusion portion is positioned on the center of each of the reflective plate units and toward one of the LEDs.

3. The direct type backlight module as claimed in claim 1, wherein an aperture ratio per unit area of the transmitting holes increases as the distance to the corresponding one of the LEDs increases.

4. The direct type backlight module as claimed in claim 1, wherein the number of the transmitting holes per unit area increases as the distance to the corresponding one of the LEDs increases.

5. The direct type backlight module as claimed in claim 1, wherein the reflective plate is integrally formed.

6. The direct type backlight module as claimed in claim 1, wherein the reflective plate is made of a sheet metal with high reflectivity.

7. The direct type backlight module as claimed in claim 1, wherein the reflective plate is made of a plastic material with high reflectivity.

8. The direct type backlight module as claimed in claim 1, wherein the reflective plate is spliced together by a plurality of reflective plate units.

9. The direct type backlight module as claimed in claim 8, wherein the reflective plate unit is made of a metal sheet with high reflectivity.

10. The direct type backlight module as claimed in claim 8, wherein the reflective plate unit is made of a plastic material with high reflectivity.

11. The direct type backlight module as claimed in claim 1, wherein the direct type backlight module further includes a plastic frame and an optical film, the optical film is mounted on the side of reflective plate opposite to the housing.

12. The direct type backlight module as claimed in claim 11, wherein the plastic frame is a rectangular frame.

13. The direct type backlight module as claimed in claim 11, wherein the plastic frame includes an upper frame, a lower frame, and protrusion located between the upper frame and the lower frame.

14. The direct type backlight module as claimed in claim 13, wherein the upper frame and the protrusion cooperatively define a receiving portion for receiving the optical film.

15. The direct type backlight module as claimed in claim 11, wherein the reflective plate and the optical film cooperatively define a mixing light distance.

16. The direct type backlight module as claimed in claim 15, wherein the light mixing distance is equal to 0.2 mm.

17. The direct type backlight module as claimed in claim 15, wherein the light mixing distance is larger than 0.2 mm.

18. A LED light source device for backlighting an LCD display, A LED light source device comprising:
an array of a plurality of LEDs positioned above a reflective sheet and below a reflective plate, wherein the LEDs and the reflective sheet are oriented to direct light rays emitted from the LEDs toward the reflective plate;
the reflective plate comprises an array of frusto-conically shaped, downwardly recessed projection portions, wherein each projection portion is positioned above, and substantially opposite to one of the plurality of LEDs, and
wherein each projection portion comprises a plurality of light transmitting holes configured for redirecting light rays from a corresponding LED toward an optical film.
